(19) United States
(12) Patent Application Publication
(10) Pub. No.: US 2004/0236610 A1
(43) Pub. Date: Nov. 25, 2004

(54) Medical apparatus remote support service method, system, and program

(76) Inventors: Takayuki Nagaoka, Chiba (JP); Yoshikazu Igeta, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/482,784

(22) PCT Filed: Jul. 3, 2002
(86) PCT No.: PCT/JP02/06735

(30) Foreign Application Priority Data
Jul. 4, 2001 (JP) 2001-203743

(51) Int. Cl. G06F 17/60; G06F 17/00; G06F 7/00

(52) U.S. Cl. 705/3; 707/104.1

(57) ABSTRACT

A medical apparatus (130) transmits a data file to a computer (100) for maintenance. The maintenance computer (100) stores the received file and transmits operation image information fetched from the medical apparatus (13) together with the stored data file to a computer (110) for support. The support computer (110) transmits support information to the maintenance computer (100) in accordance with the received data file and the operation image information. Thus, it is possible to perform correct diagnosis of the medical apparatus.

### TECHNICAL FIELD

The present invention relates to medical apparatus remote support service method, system, and program, and more particularly to, medical apparatus remote support service method, system, and program which remotely support maintenance of the medical apparatus, customer services, and on-site services using the apparatus.

### BACKGROUND ART

Heretofore, a medical apparatus, which is used in medical apparatus remote support service method, system, and program, is in use for diagnosis of the living body, and when it gets out of order, it seriously affects the diagnosis. The medical apparatus is also used often in an emergency, therefore it is desirably available at all times. In addition, in order to prevent failures, the medical apparatus requires periodic maintenance.

Meanwhile, conventional medical apparatus remote support service method, system, and program suffer from a problem that the medical apparatus needs time, which is not short, for maintenance or repairing thereof and it thus becomes unavailable for a while.

In particular, when the medical apparatus is repaired due to an occurrence of something abnormal, a time period from the occurrence of the abnormal condition until a repair serviceperson reaches a site, or a time period required to examine the cause of the occurrence of the abnormal condition, is indeterminate, raising a problem that the medical apparatus is unavailable in an emergency.

For such a situation, remote maintenance is applicable for remotely repairing and maintaining. Disclosed in Japanese Unexamined Patent Publication No. 6-62130 is a medical apparatus remote diagnosis system which appropriately activates a self-diagnostic program and automatically reports failures. Also disclosed in Japanese Unexamined Patent Publication No. 10-3452 is a medical device service system which remotely executes a self-diagnostic program.

The above-described systems, however, have disadvantages that there is a case where the self-diagnostic program cannot be executed because the systems remotely perform maintenance by the self-diagnosis program but the program itself which is a diagnostic target is provided in the medical apparatus.

Moreover, when a system itself including the self-diagnostic program is in abnormal conditions, the system is unable to properly diagnose.

The present invention is devised in light of such situation and to provide medical apparatus remote support service method, system, and program which are capable of properly diagnosing a medical apparatus.

### SUMMARY OF THE INVENTION

In order to attain the foregoing objects, a medical apparatus remote support service method of the present invention is characterized by comprising: a step of setting a file request to a maintenance computer, the file request transmitting a data file to the maintenance computer, the data file including at least one of a setting value, an image, and a log file, generated in a medical apparatus; a step of transmitting the data file from the medical apparatus to the maintenance computer upon the file request and storing the data file in the maintenance computer; a step of setting an access request to a support computer, the access request transmitting the data file stored in the maintenance computer to the support computer; and a step of transmitting the data file from the maintenance computer to the support computer upon the access request.

Moreover, a medical apparatus remote support service system of the present invention is characterized by comprising: a medical apparatus; a maintenance computer placed at a same customer site as that of the medical apparatus, the maintenance computer being connected to the medical apparatus; and a support computer placed at a support center of the medical apparatus and connected to the maintenance computer via a communication network, wherein: the medical apparatus transmits a data file including at least one of a setting value, an image, and a log file of the medical apparatus, to the maintenance computer upon receipt of a file request from the maintenance computer, the maintenance computer acquires the data file from the medical apparatus upon the file request and stores the data file in a storage medium, and transmits the data file stored in the storage medium to the support computer upon receipt of an access request from the support computer, and the support computer receives the data file from the maintenance computer upon the access request, and transmits data of at least one of a file correction request and operation support information to the maintenance computer when necessary.

Furthermore, a medical apparatus remote support service program of the present invention is characterized in that the program allows a maintenance computer, placed at a same customer site as that of a medical apparatus and connected to the medical apparatus, to implement: a file acquisition function of transmitting a file request to the medical apparatus and acquiring a data file transmitted from the medical apparatus upon the file request, the data file including at least one of a setting value, an image, and a log file, of the medical apparatus; a function of storing the acquired data file in a storage medium; and a function of transmitting the stored data file to a support computer in response to an access request from a support computer connected to the maintenance computer via a communication network.

According to the present invention, the medical apparatus transmits a data file to the maintenance computer, the maintenance computer transmits to a support computer the received data file and operation image information acquired from the medical apparatus, and the support computer transmits support information to the maintenance computer in accordance with the received data file and the operation image information. Thus, it is possible to positively execute a diagnosis program of the medical apparatus even under abnormal conditions of the apparatus, and to remotely find out that the apparatus is in abnormal conditions.

### BRIEF DESCRIPTION OF THE DRAWINGS

FIG. 1 is a block diagram showing a hardware constitution example of medical apparatus remote support service method, system, and program according to the present invention;

FIG. 2 is a flowchart showing an embodiment of the medical apparatus remote support service method and program according to the present invention;

FIG. 3 is a flowchart showing another embodiment of the medical apparatus remote support service method and program according to the present invention;

FIG. 4 is a flowchart showing still another embodiment of the medical apparatus remote support service method and program according to the present invention;

FIG. 5 is a diagram showing a chart created for each medical apparatus by a maintenance computer;

FIG. 6 is a diagram showing an example of supporting maintenance of the medical apparatus for an on-site serviceperson, using the maintenance computer; and

FIG. 7 is a diagram showing an example of distributing information to a customer by the maintenance computer in a site where the medical apparatus is placed.

### THE PREFERRED EMBODIMENTS FOR CARRYING OUT THE INVENTION

Preferred embodiments of medical apparatus remote support service method, system, and program according to the present invention will be described below in detail with reference to the accompanied drawings.

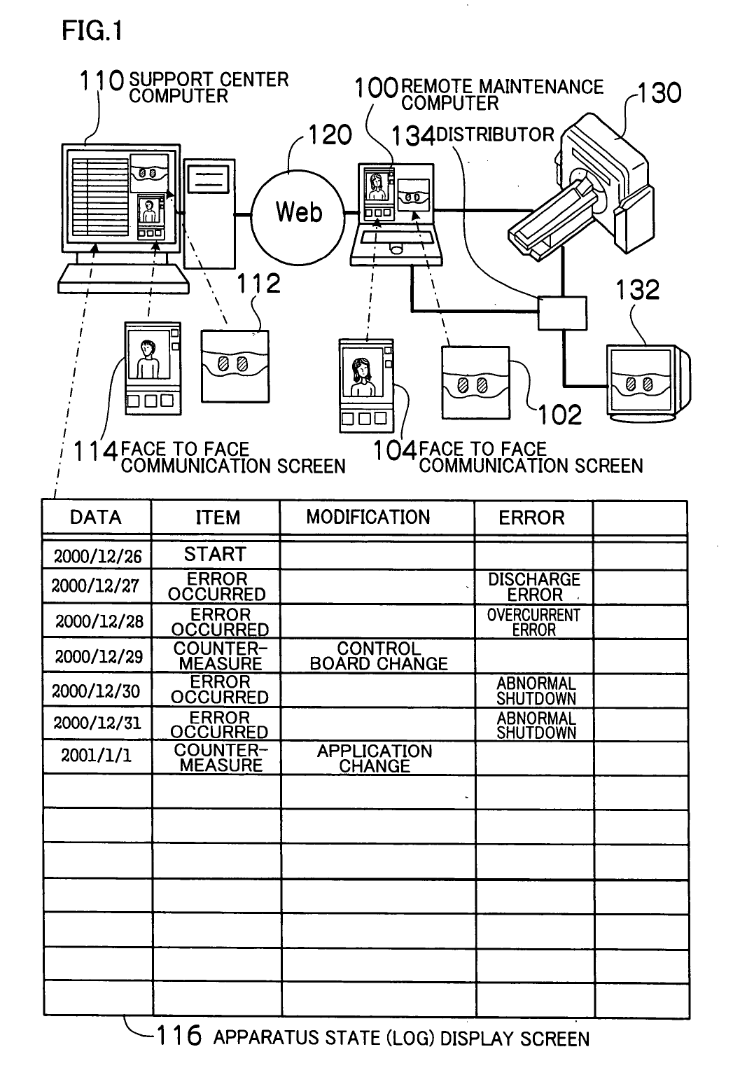

FIG. 1 is a diagram showing the entire constitution in one embodiment of the medical apparatus remote support service method, system, and program according to the present invention. As shown in FIG. 1, the medical apparatus remote support service system according to the present invention mainly comprises a maintenance computer 100 operable as a Web server placed in a customer site, a support computer 110 operable as a Web client placed at a support center, and a medical apparatus 130 for picking up a medical image from a subject body to be inspected.

The maintenance computer 100 is connected to the medical apparatus 130 and placed in the same customer site as the medical apparatus 130. The maintenance computer 100 is activated by a power source independent of the medical apparatus 130. The support computer 110 is placed at the support center in a site different and remote from where the medical apparatus 130 resides.

The maintenance computer 100 and the support computer 110 are connected with each other via a communication network (Web) 120 such as the Internet so that the both devices can communicate information therebetween.

The medical apparatus 130 is connected via a distributor 134 to a display apparatus 132 for displaying the medical image picked up by the medical apparatus 130. A display signal, which represents operation image information, is outputted from the medical apparatus 130 and is then distributed by the distributor 134 to be outputted to the display apparatus 132 and the maintenance computer 100. By inputting the display signal via discrete lines by the distributor 134, the maintenance computer 100 can acquire the operation image information 102 without causing a load on the CPU of the medical apparatus 130.

On a display screen of the maintenance computer 100, displayed are the operation image information 102 outputting the medical image fetched from the medical apparatus 130 via the distributor 134, and a counterview communication screen 104 used to provide operational supports from a support staff in the support center to a customer.

When the operational support is provided to the customer, the customer can visually receive the operational support viewing the fetched operation image information 102 and the counterview communication screen 104 projecting the support staff in the support center both of which are displayed on the display screen of the maintenance computer 100.

On a display screen of the support computer 110, when the operational support is provided to the customer, displayed are an operation image information 112 outputting the medical image fetched from the medical apparatus 130, a counterview communication screen 114 outputting a condition of the customer on a site, and an apparatus state (log) display screen 116 outputting a state (log) of the medical apparatus and the like.

Note here that, the state of the medical apparatus outputted on the apparatus state display screen 116 is not limited to the log, and a list of setting values, image data to be recorded, a configuration of the medical apparatus (version, etc.), or the like, can be switched and displayed from one to another.

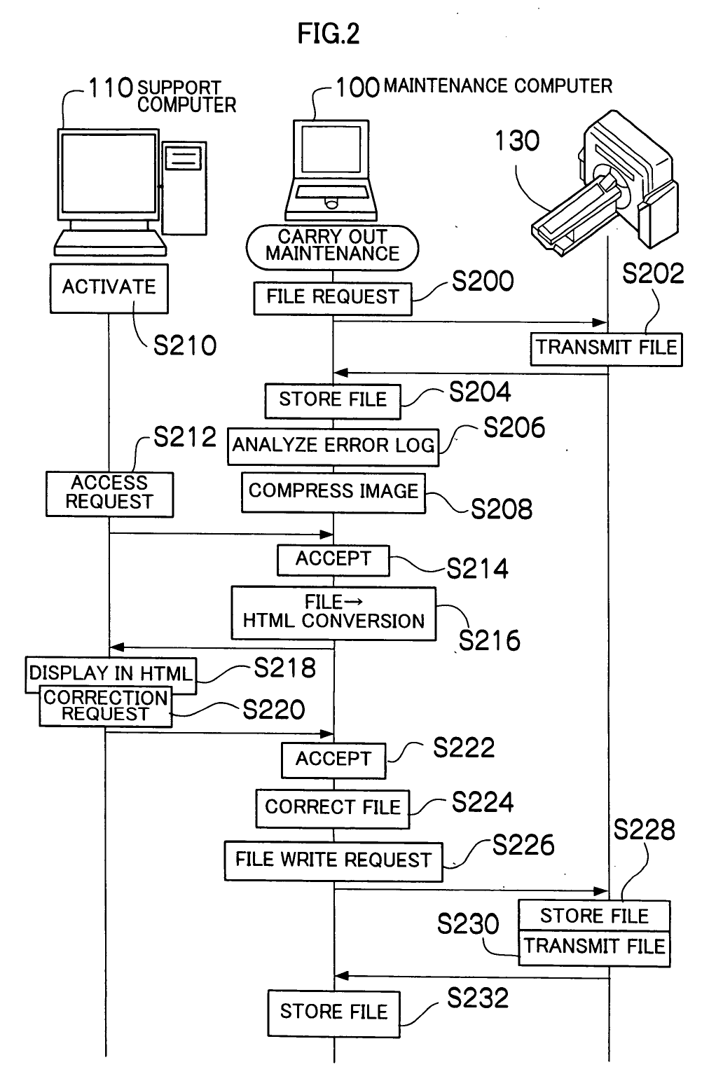

FIG. 2 is a flowchart for the embodiment of the medical apparatus remote support service program according to the present invention. As shown in FIG. 2, when carrying out the maintenance of the medical apparatus 130, the operator initiates the operation of the maintenance computer 100. Then, the operator inputs transmission request information for requesting the medical apparatus 130 to transmit a data file including setting values, images, log files, and the like, of the apparatus in step S200 (hereinafter abbreviated to as S200) of “file request”.

Subsequently in S202 of “transmit file”, the medical apparatus 130 transmits the data file to the maintenance computer 100 in accordance with a direction of the file request inputted by the operator in S200.

Upon receipt of the transmitted data file, the maintenance computer 100 stores the data file onto a storage medium in S204 of “store file”.

Next in S206 of “analyze error log”, the maintenance computer 100 analyzes whether the stored data file includes an error log.

Since the maintenance computer 100 itself is operable as a Web server, it converts the data file received from the medical apparatus 130 in S202 to an HTML or XML file in accordance with items such as images, error logs, operation logs, and the like.

Note here that a log file such as the error log is arranged in a table form in time sequence or by the error item so that it is apparent when and which error has occurred. Moreover, the error item of the error log file is described in association with a factor causing the occurrence of the error and a countermeasure therefor by means of hyperlink.

In S208 of “compress image”, the maintenance computer 100 compresses image data of large file size in the received data file into a JPEG format and the like, and describes the resultant data in the HTML file.

Next, when the support computer 110 supports the maintenance of the medical apparatus 130, the support computer 110 is activated in S210 of “activate”.

Subsequently, the support computer 110 is connected to the maintenance computer 100 via a communication network through a browser.

In S212 of “access request”, the support computer 110 transmits an access request command for the data file to the interconnecting maintenance computer 100. In accordance with the access request command transmitted from the support computer 110, the maintenance computer 100 displays an access authentication screen on a browser to request a user name and a password from the support computer 110.

When the pre-registered user name and password are inputted from the support computer 110 and it is authenticated as a terminal permitted to provide the operational support by the maintenance computer 100 in S214 of “accept”, the support computer 110 and the maintenance computer 100 become able to communicate with each other.

Next, the display signal representing the operation image information transmitted from the medical apparatus 130 is distributed by the distributor 134, and converted to a video signal by a scan converter, and subsequently transmitted to the maintenance computer 100 by virtue of video capture.

Upon receipt of the signal transmitted from the medical apparatus 130, the maintenance computer 100 displays a state of the medical apparatus 130 in the operation image information 102.

When the state of the medical apparatus 130 is displayed, the maintenance computer 100 converts the displayed image data to the HTML in real time in S216 of “file→HTML conversion”.

After the HTML conversion, the maintenance computer 100 transmits an HTML display command to the support computer 110. Upon receipt of the HTML command, the support computer 110, in S218 of “display in HTML”, displays the state of the medical apparatus 130 in the operation image information 112 by the browser in real time.

It is to be understood that the state of the medical apparatus 130 displayed at the support computer 110 includes a current activation status, a log file last stored by the maintenance computer 100, a setting value file, a list of image files, and the operation image information.

The support computer 110 compares the operation image information 112 displaying the state of the medical apparatus 130 with the stored data file to thereby diagnose the current state.

When the apparatus state display screen 116 displayed in S218 includes the error log representing the record of an abnormal condition of the medical apparatus 130, the support computer 110 transmits a correction request command of the data file to the maintenance computer 100 in S220 of “correction request”. The maintenance computer 100 authenticates on the basis of the received correction request command whether the support computer 110 is a terminal permitted to communicate with.

When an authentication result is obtained such that the support computer 110 is a terminal permitted to communicate with, the maintenance computer 100 and the support computer 110 become able to communicate with each other in S222 of “accept”.

After the mutual computers go into the communication-capable state, the maintenance computer 100 corrects the data file in S224 of “correct file”.

After the correction of the data file, the maintenance computer 100 transmits a file write request command to the medical apparatus 130 in S226 of “file write request”. When the medical apparatus 130 receives the file write request command, the maintenance computer 100 writes the corrected data file in the medical apparatus 130 to thereby correct the data file.

Subsequently in S228 of “store file”, the medical apparatus 130 stores the corrected data file, and transmits the stored data file to the maintenance computer 100 in S230 of “transmit file”.

Next in S232 of “store file”, the maintenance computer 100 stores the received data file.

When the medical apparatus 130 is found to be abnormal in hardware thereof as a result of the error log analysis, the support computer 110 transmits to the maintenance computer 100 an activation request command for activating a check program provided to the medical apparatus 130. In accordance with the received activation request command, the maintenance computer 100 inputs dummy data to the hardware of the medical apparatus 130 to examine a result outputted therefrom, and then discovers an abnormal location of the hardware.

When the abnormal location in the hardware of the medical apparatus 130 is discovered, the maintenance computer 100 creates a report indicating the abnormality by the unit and transmits a report display command to the support computer 110. Upon receipt of the report display command, the support computer 110 displays on the browser the report indicating the abnormality.

At the support center, the report displayed on the browser of the support computer 110 which indicates the abnormality by the unit of the medical apparatus 130 is referred, and an order of parts is placed.

Distribution of dynamic images via the communication network is a technique having been implemented by an Internet camera; however, the medical apparatus remote support service method, system, and program according to the present invention allow real-time acquisition of the operation image information for the medical image without causing a load on the CPU of the medical apparatus.

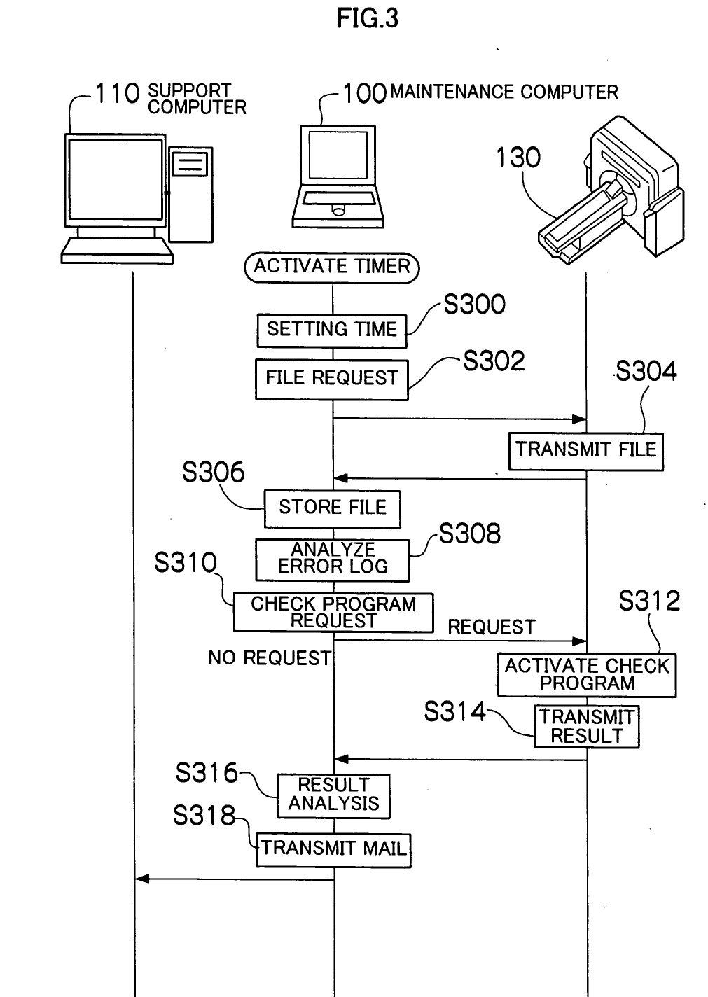

FIG. 3 is a flowchart showing another embodiment of the medical apparatus remote support service program according to the present invention. As shown in FIG. 3, upon diagnosis of periodic backup for the medical apparatus 130, the operator activates a timer of the maintenance computer 100. Then, the operator sets the time when the backup is executed, in S300 of “setting time”.

In S302 of “file request”, the operator inputs transmission request information for requesting the medical apparatus 130 to transmit the data file including setting values, images, log files, and the like, of the apparatus.

Subsequently in S304 of “transmit file”, the medical apparatus 130 transmits the data file to the maintenance computer 100 in accordance with the direction of the file request inputted by the operator in S302.

Upon receipt of the transmitted data file, the maintenance computer 100 stores the data file onto a storage medium in S306 of “store file”.

Then, in S308 of “analyze error log”, the maintenance computer 100 analyzes the error log of the stored data file.

When the check program is not requested as a result of the analysis in S308, an analysis result obtained in S308 is represented in the maintenance computer 100 in S316 of “analyze result”.

In S318 of “transmit mail”, the maintenance computer 100 transmits an electronic mail indicating the analysis result of S316 to the support computer 110 placed at the support center.

When an abnormal phenomenon, for example, frequent occurrence of specific errors, is diagnosed as the result of the analysis in S308, the maintenance computer 100 transmits a request command for requesting the medical apparatus 130 to activate the check program provided thereto in S310 of “check program request”, simultaneously with the mail transmission in S318.

In S312 of “activate check program”, the medical apparatus 130 activates the check program for checking the analysis result obtained in S308 in accordance with the received request command, and diagnoses the hardware.

In S314 of “transmit result”, the medical apparatus 130 transmits a diagnosis result obtained in S312 to the maintenance computer 100.

In the present invention, it is not designed so that a registered program is automatically executed whenever a clock built in the maintenance computer 100 reaches a pre-set time, but the maintenance computer 100 periodically receives the data file from the medical apparatus 130 in accordance with a schedule management program preset by the maintenance computer 100 to thereby executes the backup.

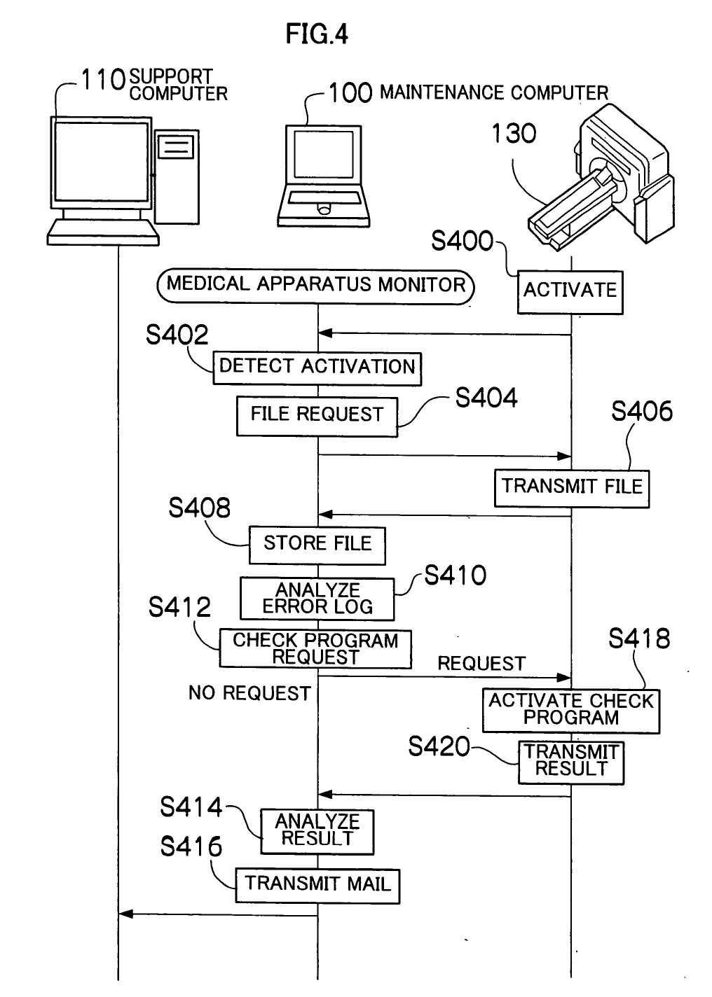

FIG. 4 is a flowchart showing still another embodiment of the medical apparatus remote support service program according to the present invention. As shown in FIG. 4, when the backup is executed after the activation of the medical apparatus 130, the medical apparatus 130 is first activated in S400 of “activate”, and thereafter the maintenance computer 100 detects the activation of the medical apparatus 130 in S402 of “detect activation”.

In S404 of “file request”, the operator inputs transmission request information for requesting the medical apparatus 130 to transmit the data file including setting values, images, log files, and the like, of the apparatus.

Then, in S406 of “transmit file”, the medical apparatus 130 transmits the data file to the maintenance computer 100 in accordance with the direction of the file request inputted by the operator in S404.

Upon receipt of the transmitted data file, the maintenance computer 100 stores the data file onto a storage medium in S408 of “store file”.

Subsequently in S410 of “analyze error log”, the maintenance computer 100 analyzes an error log in the stored data file.

Next, when the check program is not requested as a result of the analysis in S410, an analysis result obtained in S410 is represented in the maintenance computer 100 in S414 of “analyze result”.

In S416 of “transmit mail”, the maintenance computer 100 transmits an electronic mail indicating the analysis result of S414 to the support computer 110 placed at the support center.

When an abnormal phenomenon, for example, frequent occurrence of specific errors, is diagnosed as the result of the analysis in S410, the maintenance computer 100 transmits a request command for requesting the medical apparatus 130 to activate the check program provided thereto in S412 of “check program request”, simultaneously with the mail transmission in S416.

In S418 of “activate check program”, the medical apparatus 130 activates the check program for checking the analysis result obtained in S410 in accordance with the received request command, and diagnoses the hardware.

In S420 of “transmit result”, the medical apparatus 130 transmits the diagnosis result obtained in S418 to the maintenance computer 100.

When the backup is executed upon shut-down of the medical apparatus 130, a monitor agent program provided to the medical apparatus 130 is run in the background to determine the shut-down of the apparatus. The program executes file transfer in shut-down processing of the medical apparatus 130. The program does not run except when the shut-down processing of the medical apparatus 130 is being executed, so that the load on the CPU in the apparatus is hardly generated.

When the medical apparatus 130 is shut-down and other active programs sequentially go into the shut-down processing, shut-down processing for the program is also invoked from a system of the medical apparatus 130.

In the present invention, the maintenance computer 100 monitors a state of the medical apparatus 130 by always having connection therewith and monitoring a voltage of an interface or the like. When detecting the state immediately after the activation or immediately before the shut-down of the medical apparatus 130, the maintenance computer 100 receives instantly the data file from the medical apparatus 130, and executes the backup.

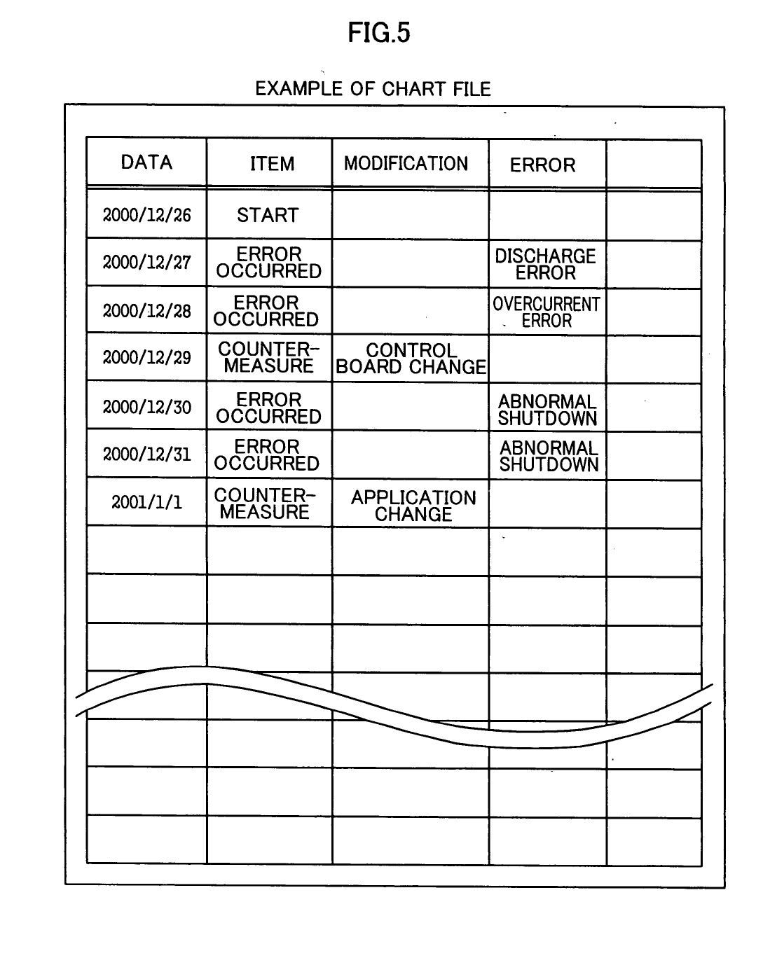

FIG. 5 shows a chart created for each medical apparatus by the maintenance computer. As shown in FIG. 5, the created chart records changes in the state of the medical apparatus 130 such as updates of files, changes of software, modification of constitution hardware in time sequence.

The maintenance computer 100 monitors the state of the medical apparatus 130, according to which time-series update records since the medical apparatus 130 was set up until the present time are added and described at any time in a chart file of the maintenance computer 100. The chart has the records of the frequency of occurrence of each error arranged in time sequence and statues of use such as the number of imaging, which thus allows prediction on the replacement timing of expendable supplies and on the occurrence of abnormality.

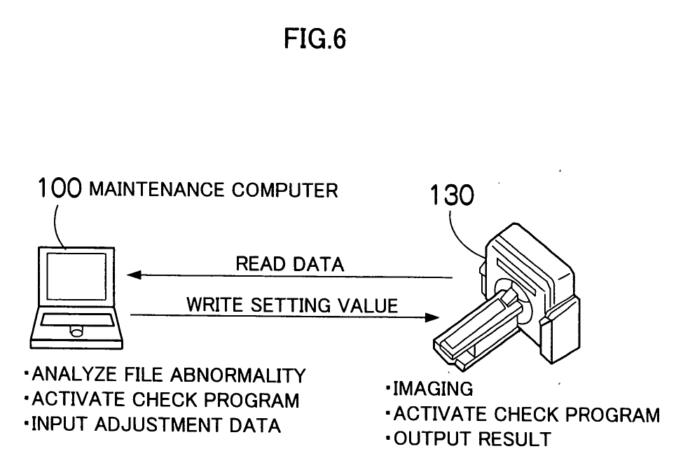

FIG. 6 shows an example of supporting maintenance of the medical apparatus for an on-site serviceperson, using the maintenance computer. As shown in FIG. 6, the maintenance computer 100 and the medical apparatus 130 are connected with each other so that the devices can communicate with each other.

The maintenance computer 100 has input means for reading data from the medical apparatus 130 and display means for displaying the processing contents.

At a site where the medical apparatus 130 is placed, the on-site serviceperson can conduct the maintenance of the medical apparatus 130 using the maintenance computer 100 by analyzing a file anomaly, activating the check program of the medical apparatus 130, inputting/outputting adjustment data, and the like.

The maintenance computer 100 is also available as setting value input means for inputting setting values to the medical apparatus 130. Upon the adjustment of the medical apparatus 130, the medical apparatus 130 receives inputs of the setting values outputted from the maintenance computer 100 and picks up a medical image, to thereby make fine adjustments based on the picked up image or operations.

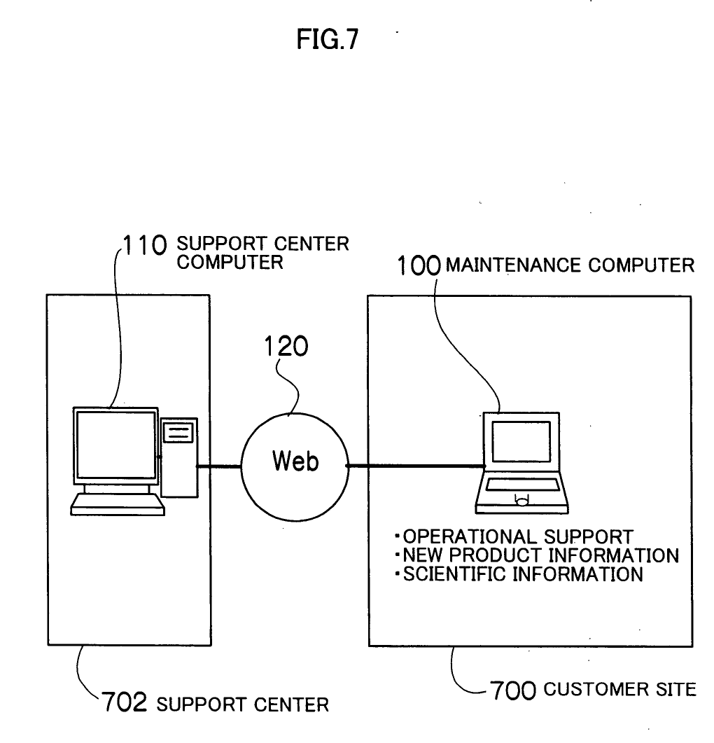

FIG. 7 shows an example of distributing information to a customer by the maintenance computer at the site where the medical apparatus is placed. As shown in FIG. 7, the maintenance computer 100 with the display means placed at the customer site 700 and the support computer 110 placed at the support center 702 are connected with each other via the communication network 120.

The customer can acquire operational supports and information such as new product information and scientific information from the support center 702 using the maintenance computer 100 placed at the customer site 700 by communicating with the support computer 110 placed at the support center 702.

The medical apparatus remote support service method, system, and program according to the present invention are constituted so that the medical apparatus is connected individually to the support computer via the maintenance computer without using a PACS (Picture Archiving Communication System). Therefore, the operation image information outputted from the medical apparatus is transferred without the CPU operation, thereby allowing the reduction of CPU load.

Moreover, when the present invention is employed, information can be periodically received, and in addition thereto, the maintenance can be provided equally to changes in the medical apparatus (activation, error occurrence, shut-down, etc).

Further, the above embodiments have described that the remote service program is executed upon the file request of the maintenance computer; however, it is also allowable that the access request of the support computer induces the maintenance computer to make the file request so that the remote service program may be executed. By doing this, the support center is allowed to execute the identical file request for a plurality of customer sites, thus enabling the overall management of a plurality of customer sites.

Furthermore, when the remote service program is executed upon the access request of the support center, the two aspects are applicable, such that the medical apparatus file is transmitted to the support computer via the maintenance computer, and such that storage of the medical apparatus file into the maintenance computer and transmission of the medical apparatus file to the support computer are carried out in parallel. In this aspect of parallel operations of storage and transmission, files of a plurality of customer sites can be transmitted promptly to the support computer. In this case, the data file may not be stored in the maintenance computer.

### INDUSTRIAL APPLICABILITY

As described above, according to the medical apparatus remote support service method, system, and program of the present invention, the support computer transmits support information to the maintenance computer in accordance with the data file and the like received from the maintenance computer, therefore it is possible to properly diagnose the medical apparatus and to support operations thereof.

1. A medical apparatus remote support service method, comprising:
a step of setting a file request to a maintenance computer, the file request transmitting a data file to the maintenance computer, the data file including at least one of a setting value, an image, and a log file, generated in a medical apparatus;
a step of transmitting the data file from the medical apparatus to the maintenance computer upon the file request and storing the data file in the maintenance computer;
a step of setting an access request to a support computer, the access request transmitting the data file stored in the maintenance computer to the support computer; and
a step of transmitting the data file from the maintenance computer to the support computer upon the access request.

2. A medical apparatus remote support service method, comprising:
a step of setting an access request to a support computer, the access request transmitting a data file to the support computer, the data file including at least one of a setting value, an image, and a log file, generated in a medical apparatus;
a step of setting a file request to a maintenance computer, the file request transmitting the data file from the medical apparatus to the maintenance computer upon the access request; and
a step of transmitting the data file from the medical apparatus to the maintenance computer upon the file request and transmitting the data file from the maintenance computer to the support computer.

3. A medical apparatus remote support service method, comprising:
a step of setting an access request to a support computer, the access request transmitting a data file to the support computer, the data file including at least one of a setting value, an image, and a log file, generated in a medical apparatus;
a step of setting a file request to a maintenance computer, the file request transmitting the data file from the medical apparatus in parallel to the maintenance computer and the support computer upon the access request; and
a step of transmitting the data file from the medical apparatus in parallel to the maintenance computer and the support computer upon the file request.

4. A medial apparatus remote support service system, comprising:
a medical apparatus;
a maintenance computer placed at a same customer site as that of the medical apparatus, the maintenance computer being connected to the medical apparatus; and
a support computer placed at a support center of the medical apparatus and connected to the maintenance computer via a communication network, wherein:
the medical apparatus transmits a data file including at least one of a setting value, an image, and a log file of the medical apparatus, to the maintenance computer upon receipt of a file request from the maintenance computer,
the maintenance computer acquires the data file from the medical apparatus upon the file request and stores the data file in a storage medium, and transmits the data file stored in the storage medium to the support computer upon receipt of an access request from the support computer, and
the support computer receives the data file from the maintenance computer upon the access request, and transmits data of at least one of a file correction request and operation support information to the maintenance computer when necessary.

5. A medical apparatus remote support service system according to claim 4, wherein the maintenance computer periodically transmits the file request.

6. A medical apparatus remote support service system according to claim 4, wherein the maintenance computer transmits the file request at least one of immediately after activation of the medical apparatus and immediately before shut-down of the medical apparatus.

7. A medical apparatus remote support service system according to claim 4, wherein the maintenance computer has means for monitoring a state of the medical apparatus and creating a chart file in which changes in the state of the medical apparatus are recorded in time sequence.

8. A medical apparatus remote support service system according to claim 4, wherein the maintenance computer acquires operation image information from the medical apparatus, and transmits the acquired operation image information together with the data file stored in the storage medium to the support computer upon receipt of the access request from the support computer.

9. A medical apparatus remote support service system according to claim 8, wherein the maintenance computer fetches the operation image information distributed by a distributor, which is outputted from the medical apparatus onto display means thereof.

10. A medical apparatus remote support service system according to claim 8, wherein:
the maintenance computer creates in real time at least one of an HTML file and an XML file in accordance with the data file stored in the storage medium and the acquired operation image information; and
the support computer displays in real time at least one of the HTML file and the XML file on a browser.

11. A medical apparatus remote support service system, comprising:
means for setting a file request to a maintenance computer, the file request transmitting a data file to the maintenance computer, the data file including at least one of a setting value, an image, and a log file, generated in a medical apparatus;
means for transmitting the data file from the medical apparatus to the maintenance computer upon the file request and storing the data file in the maintenance computer;
means for setting an access request to a support computer, the access request transmitting the data file stored in the maintenance computer to the support computer; and
means for transmitting the data file from the maintenance computer to the support computer upon the access request.

12. A medical apparatus remote support service system, comprising:
means for setting an access request to a support computer, the access request transmitting a data file to the support computer, the data file including at least one of a setting value, an image, and a log file, generated in a medical apparatus;
means for setting a file request to a maintenance computer, the file request transmitting the data file from the medical apparatus to the maintenance computer upon the access request; and
means for transmitting the data file from the medical apparatus to the maintenance computer upon the file request and transmitting the data file from the maintenance computer to the support computer.

13. A medical apparatus remote support service system, comprising:
means for setting an access request to a support computer, the access request transmitting a data file to the support computer, the data file including at least one of a setting value, an image, and a log file, generated in a medical apparatus;
means for setting a file request to a maintenance computer, the file request transmitting the data file from the medical apparatus in parallel to the maintenance computer and the support computer upon the access request; and
means for transmitting the data file from the medical apparatus in parallel to the maintenance computer and the support computer upon the file request.

14. A medical apparatus remote support service program which allows a maintenance computer, placed at a same customer site as that of a medical apparatus and connected to the medical apparatus, to implement:
a file acquisition function of transmitting a file request to the medical apparatus and acquiring a data file transmitted from the medical apparatus upon the file request, the data file including at least one of a setting value, an image, and a log file, of the medical apparatus;
a function of storing the acquired data file in a storage medium; and
a function of transmitting the stored data file to a support computer in response to an access request from a support computer connected to the maintenance computer via a communication network.

15. A medical apparatus remote support service program according to claim 14, wherein the file acquisition function periodically transmits the file request.

16. A medical apparatus remote support service program according to claim 14, wherein the file acquisition function transmits the file request at least one of immediately after activation of the medical apparatus and immediately before shut-down of the medical apparatus.

17. A medical apparatus remote support service program according to claim 14, further allowing the maintenance computer to implement:
a function of monitoring a state of the medical apparatus and creating a chart file in which changes in the state of the medical apparatus are recorded in time sequence.

18. A medical apparatus remote support service program according to claim 14, further allowing the maintenance computer to implement:
a function of acquiring operation image information from the medical apparatus; and
a function of transmitting the acquired operation image information together with the data file stored in the storage medium to the support computer in response to the access request from the support computer.

19. A medical apparatus remote support service program according to claim 18, further allowing the maintenance computer to implement:
a function of creating in real time at least one of an HTML file and an XML file in accordance with the data file stored in the storage medium and the acquired operation image information.

20. A medical apparatus remote support service program which implements:
a function of setting a file request to a maintenance computer, the file request transmitting a data file to the maintenance computer, the data file including at least one of a setting value, an image, and a log file, generated in a medical apparatus;
a function of transmitting the data file from the medical apparatus to the maintenance computer upon the file request and storing the data file in the maintenance computer;
a function of setting an access request to a support computer, the access request transmitting the data file stored in the maintenance computer to the support computer; and
a function of transmitting the data file from the maintenance computer to the support computer upon the access request.

21. A medical apparatus remote support service program which implements:
a function of setting an access request to a support computer, the access request transmitting a data file to the support computer, the data file including at least one of a setting value, an image, and a log file, generated in a medical apparatus;
a function of setting a file request to a maintenance computer, the file request transmitting the data file from the medical apparatus to the maintenance computer upon the access request; and
a function of transmitting the data file from the medical apparatus to the maintenance computer upon the file request and transmitting the data file from the maintenance computer to the support computer.

22. A medical apparatus remote support service program which implements:
a function of setting an access request to a support computer, the access request transmitting a data file to the support computer, the data file including at least one of a setting value, an image, and a log file, generated in a medical apparatus;
a function of setting a file request to a maintenance computer, the file request transmitting the data file from the medical apparatus in parallel to the maintenance computer and the support computer upon the access request; and
a function of transmitting the data file from the medical apparatus in parallel to the maintenance computer and the support computer upon the file request.
